(19) United States
(12) Patent Application Publication
(10) Pub. No.: US 2026/0304118 A1
(43) Pub. Date: Oct. 1, 2026

(54) FEDERATED LEARNING (FL) IN ARTIFICIAL INTELLIGENCE (AI) AND MACHINE LEARNING (ML)

(71) Applicant: Lenovo (United States) Inc., Morrisville, NC (US)

(72) Inventor: Sheeba Backia Mary Baskaran, Friedrichsdorf (DE)

(73) Assignee: Lenovo (United States) Inc., Morrisville, NC (US)

(21) Appl. No.: 19/091,696

(22) Filed: Mar. 26, 2025

(51) Int. Cl. H04W 12/069; H04L 41/16; H04W 8/18

(52) U.S. Cl. CPC H04W 12/069; H04L 41/16; H04W 8/186

(57) ABSTRACT

Various aspects of the present disclosure relate to federated learning (FL) in artificial intelligence (AI) and machine learning (ML). An apparatus, such as a network equipment (NE), receives a first message including a request for an access token, where the first message includes first artificial intelligence (AI) machine learning (ML) information associated with federated learning (FL). The apparatus transmits a second message including the access token, where the access token includes second AI/ML information associated with FL.

### TECHNICAL FIELD

The present disclosure relates to wireless communications, and more specifically to artificial intelligence (AI) and machine learning (ML) (AI/ML) in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

An apparatus (e.g., NE, network function) for wireless communication is described. The apparatus may be configured to, capable of, or operable to perform one or more operations as described herein. For example, the apparatus may be configured to, capable of, or operable to receive a first message including a request for an access token, where the first message includes first AI/ML information associated with federated learning (FL); and transmit a second message including the access token, where the access token includes second AI/ML information associated with FL.

A processor (e.g., a standalone processor chipset, or a component of an apparatus (e.g., NE, network function)) for wireless communication is described. The processor may be configured to, capable of, or operable to perform one or more operations as described herein. For example, the processor may be configured to, capable of, or operable to receive a first message including a request for an access token, where the first message includes first AI/ML information associated with FL; and transmit a second message including the access token, where the access token includes second AI/ML information associated with FL.

A method performed or performable by an apparatus (e.g., NE, network function) for wireless communication is described. The method may include receiving a first message including a request for an access token, where the first message includes first AI/ML information associated with FL; and transmitting a second message including the access token, where the access token includes second AI/ML information associated with FL.

In some implementations of the apparatus, the processor, and the method described herein, the first AI/ML information associated with FL learning includes information associated with one or more of: FL member registration service; FL member registration update service; FL events subscription service; FL events notification service; horizonal HFL training service; FL member grouping service; or vertical FL training service.

In some implementations of the apparatus, the processor, and the method described herein, the access token includes token claims for one or more of: FL member registration; FL events notification; horizontal FL (HFL) training; FL member grouping; FL member ID; FL member type (server or client); FL member capabilities; FL related events ID or name; FL type; FL task information; allowed list of member client IDs/client List; allowed location information for member client selection; FL service area of interest; allowed ML model ID list/ML model information for FL; allowed ML model training notification target address; ML model selection filtering criteria; FL member location information; analytics ID; issuer claim as an authorization server ID or an AIMLE server ID FL member; or vertical FL (VFL) training.

In some implementations of the apparatus, the processor, and the method described herein, the apparatus, the processor, and the method may further be configured to, capable of, operable to, performed to, or performable to receive a third message including an AI/ML model training request, where the third message includes security information including one or more of security credentials, authorization information, or the access token; determine one or more FL members based at least in part on a verification of the security information; and transmit, based at least in part on the determined one or more FL members, a fourth message including an AI/ML training response.

In some implementations of the apparatus, the processor, and the method described herein, the AI/ML model training request is associated with horizontal FL.

In some implementations of the apparatus, the processor, and the method described herein, the apparatus, the processor, and the method may further be configured to, capable of, operable to, performed to, or performable to receive a third message including a FL grouping request, where the third message includes security information including one or more of security credentials, authorization information, or the access token; obtain, based at least in part on verification of the security information, FL member information; and transmit, based at least in part on the FL member information, a fourth message including a FL grouping response.

In some implementations of the apparatus, the processor, and the method described herein, the NE, the processor, and the method may further be configured to, capable of, operable to, performed to, or performable to receive a third message including an AI/ML model training request, where the third message includes one or more client selection criteria and security information including one or more of security credentials, authorization information, or the access token; select one or more FL clients based at least in part a verification of the security information and the one or more client selection criteria; and transmit, based at least in part on the selected one or more FL clients, a fourth message including an AI/ML training response.

In some implementations of the apparatus, the processor, and the method described herein, the AI/ML model training request is associated with vertical FL.

In some implementations of the apparatus, the processor, and the method described herein, the NE includes an AI/ML server or an AI/ML enabler (AIMLE) server.

An apparatus (e.g., NE, network function) for wireless communication is described. The apparatus may be configured to, capable of, or operable to perform one or more operations as described herein. For example, the apparatus may be configured to, capable of, or operable to receive a first message including a registration request to register as a FL member, where the first message includes one or more of security credentials, authorization information, or an access token; and transmit a second message including a FL member registration response.

A processor (e.g., a standalone processor chipset, or a component of an apparatus (e.g., NE, network function)). The processor may be configured to, capable of, or operable to perform one or more operations as described herein. For example, the processor may be configured to, capable of, or operable to receive a first message including a registration request to register as a FL member, where the first message includes one or more of security credentials, authorization information, or an access token; and transmit a second message including a FL member registration response.

A method performed or performable by an apparatus (e.g., NE, network function) for wireless communication is described. The method may include receiving a first message including a registration request to register as a FL member, where the first message includes one or more of security credentials, authorization information, or an access token; and transmitting a second message including a FL member registration response.

In some implementations of the apparatus, the processor, and the method described herein, the apparatus, the processor, and the method may further be configured to, capable of, operable to, performed to, or performable to receive a third message including a FL event subscription request, where the third message includes one or more of the security credentials, the authorization information, or the access token; perform authorization for FL event subscription based at least in part on the one or more of the security credentials, the authorization information, or the access token; and transmit, based at least in part on the authorization for FL event subscription, a fourth message including a FL event subscription response.

In some implementations of the apparatus, the processor, and the method described herein, the apparatus includes an AI/ML repository.

In some implementations of the apparatus, the processor, and the method described herein, the security credentials include a client certificate or a root certificate configured to validate the client certificate.

An apparatus (e.g., NE, network function, UE) for wireless communication is described. The apparatus may be configured to, capable of, or operable to perform one or more operations as described herein. For example, the apparatus may be configured to, capable of, or operable to transmit a first message including a registration request to register as a FL member, where the first message includes one or more of security credentials, authorization information, or an access token; and receive a second message including a FL member registration response.

A processor (e.g., a standalone processor chipset, or a component of a NE and/or a UE) for wireless communication is described. The processor may be configured to, capable of, or operable to perform one or more operations as described herein. For example, the processor may be configured to, capable of, or operable to transmit a first message including a registration request to register as a FL member, where the first message includes one or more of security credentials, authorization information, or an access token; and receive a second message including a FL member registration response.

A method performed or performable by a NE and/or a UE for wireless communication is described. The method may include transmitting a first message including a registration request to register as a FL member, where the first message includes one or more of security credentials, authorization information, or an access token; and receiving a second message including a FL member registration response.

In some implementations of the apparatus, the processor, and the method described herein, the UE, the processor, and the method may further be configured to, capable of, operable to, performed to, or performable to transmit a third message including a FL event subscription request, where the third message includes one or more of the security credentials, the authorization information, or the access token; and receive, based at least in part on the FL event subscription request, a fourth message including a FL event subscription response.

In some implementations of the apparatus, the processor, and the method described herein, the apparatus includes one or more of a vertical application layer (VAL) server, AI/ML client, AIMLE client, AIMLE server, or an AI/ML server.

In some implementations of the apparatus, the processor, and the method described herein, the security credentials include a client certificate or a root certificate configured to validate the client certificate.

An apparatus (e.g., an NE, a UE) for wireless communication is described. The apparatus may be configured to, capable of, or operable to perform one or more operations as described herein. For example, the apparatus may be configured to, capable of, or operable to transmit a first message including a FL grouping request, where the first message includes one or more of authentication information or an access token; and receive a second message including a FL grouping response.

A processor (e.g., a standalone processor chipset, or a component of an apparatus (e.g., an NE, a network function)) for wireless communication is described. The processor may be configured to, capable of, or operable to perform one or more operations as described herein. For example, the processor may be configured to, capable of, or operable to transmit a first message including a FL grouping request, where the first message includes one or more of authentication information or an access token; and receive a second message including a FL grouping response.

A method performed or performable by an apparatus (e.g., an NE, a network function) for wireless communication is described. The method may include transmitting a first message including a FL grouping request, where the first message includes one or more of authentication information or an access token; and receiving a second message including a FL grouping response.

In some implementations of the apparatus, the processor, and the method described herein, the NE, the processor, and the method may further be configured to, capable of, operable to, performed to, or performable to transmit a third message including an AI/ML model training request, where the third message includes security information including one or more of security credentials, authorization information, or the access token; and receive, based at least in part on the AI/ML model training request, a fourth message including an AI/ML training response.

In some implementations of the apparatus, the processor, and the method described herein, the AI/ML model training request is associated with horizonal FL.

In some implementations of the apparatus, the processor, and the method described herein, the NE, the processor, and the method may further be configured to, capable of, operable to, performed to, or performable to transmit a third message including an AI/ML model training request, where the third message includes one or more client selection criteria and security information including one or more of security credentials, authorization information, or the access token; and receive, based at least in part on the AI/ML model training request, a fourth message including an AI/ML training response.

In some implementations of the apparatus, the processor, and the method described herein, the AI/ML model training request is associated with vertical FL.

In some implementations of the apparatus, the processor, and the method described herein, the apparatus includes a VAL server.

### BRIEF DESCRIPTION OF THE DRAWINGS

FIG. 1 illustrates an example of a wireless communications system in accordance with aspects of the present disclosure.

FIG. 2 illustrates an example system in accordance with aspects of the present disclosure.

FIG. 3 illustrates an example system in accordance with aspects of the present disclosure.

FIG. 4 illustrates an example system in accordance with aspects of the present disclosure.

FIG. 5 illustrates a system in accordance with aspects of the present disclosure.

FIG. 6 illustrates a system in accordance with aspects of the present disclosure.

FIG. 7 illustrates a system in accordance with aspects of the present disclosure.

FIG. 8 illustrates a system in accordance with aspects of the present disclosure.

FIG. 9 illustrates a system in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method in accordance with aspects of the present disclosure.

FIG. 14 illustrates a flowchart of a method in accordance with aspects of the present disclosure.

FIG. 15 illustrates a flowchart of a method in accordance with aspects of the present disclosure.

FIG. 16 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. By using time-frequency resources, wireless communications systems can utilize AI/ML (which may also be referred to herein as “AI” or “ML”) for a variety of different purposes, such as for network operation, network optimization, automated processing (e.g., self-driving cars in vehicle to everything (V2X) scenarios), network planning, security information and event management (SIEM)), etc. AI/ML can leverage AI/ML models (which may be referred to herein as “models”), which represent programs and/or algorithms trained on a set of data to provide outputs, such as to recognize patterns, make decisions, generate content, etc. AI/ML models, for instance, can apply different algorithms to data inputs to provide data output for performing different tasks.

AI/ML models can be trained in different ways to enable the models to perform different wireless communications tasks, including training via distributed learning (DL) and FL. In DL, training data and inference data can be distributed across multiple systems and devices, and training tasks can be performed across the multiple systems and devices. In FL, models can be trained on local systems and/or devices, where training data can be protected from possible exposure to external entities. FL can thus provide increased data security, such as compared with other training modalities such as DL.

In some wireless communications systems, an AIMLE service framework supports procedures for FL member registration, FL-related event subscription, HFL training, FL member grouping, and VFL. Some wireless communications systems, however, do not support sufficient authorization and verification, which can result in security vulnerabilities. In one example, a candidate FL member (e.g., VAL server, AIMLE server) can register to a ML registry and subscribe to FL related events notification. However, an unauthorized entity obtaining access to FL resources (e.g., registering to an FL process, performing HFL or VFL, being part of a FL group to perform FL processes) and consuming the FL events information related to the ML models for which the member has no authorization can lead to security vulnerabilities such as data breaches, model theft, data poisoning, and adversarial attacks, which may result in security and operational disruptions.

Aspects of the present disclosure are described in the context of a wireless communications system and include implementations that provide a secure environment in which different ML model tasks can be performed. In implementations, procedures are described to authorize a client (AIMLE client, VAL server, VAL UE) to participate in FL of models that participate in different AI/ML tasks in a wireless communications environment. By performing the described techniques, a wireless communications system can implement secure procedures for controlling access to different AI/ML services and resources. The described techniques can reduce unauthorized access to AI/ML services and resources, which can reduce security threats and reduce unauthorized resource usage in wireless communications systems that utilize AI/ML functionality.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

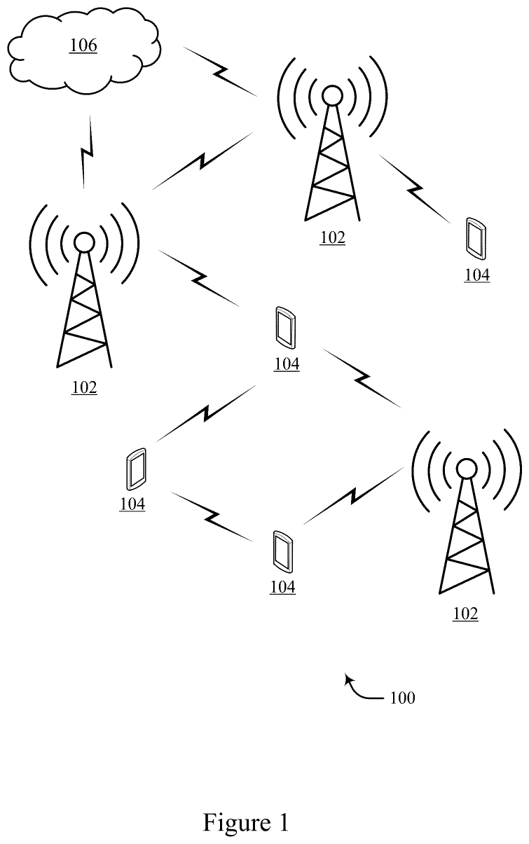

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, an NE 102 (e.g., a network function) receives (e.g., from another NE 102 and/or a UE 104) a first message including a request for an access token, where the first message includes first AI/ML information associated with FL. The NE 102 transmits a second message including the access token, where the access token includes second AI/ML information associated with FL.

According to implementations, an NE 102 receives a first message including a registration request to register as a FL member, where the first message includes one or more of security credentials, authorization information, or an access token. The NE 102 transmits a second message including a FL member registration response.

According to implementations, an NE 102 or a UE 104 transmits a first message including a registration request to register as a FL member, where the first message includes one or more of security credentials, authorization information, or an access token. The NE 102 or the UE 104 receives a second message including a FL member registration response.

According to implementations, an NE 102 transmits a first message including a FL grouping request, where the first message includes one or more of authentication information or an access token. The NE 102 receives a second message including a FL grouping response.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

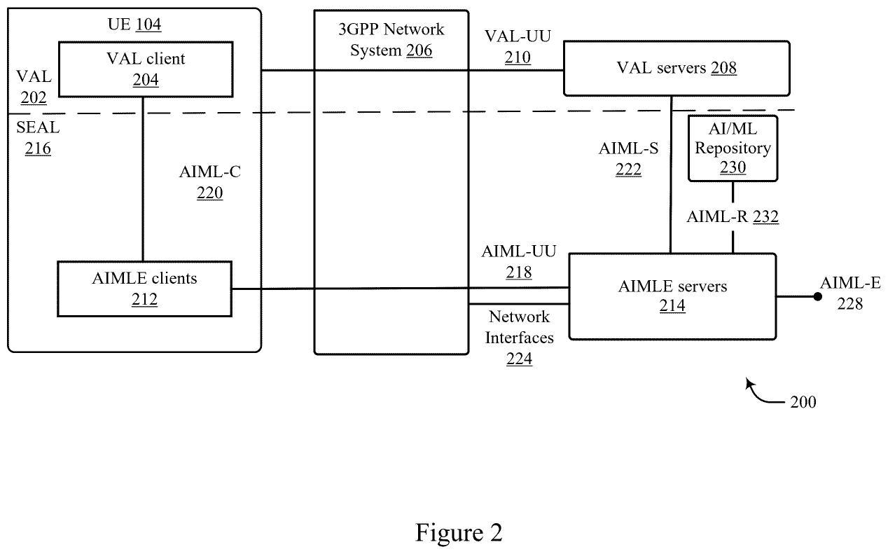

FIG. 2 illustrates an example system 200 in accordance with aspects of the present disclosure. The system 200 represents an example on-network functional model of AI/ML enablement (AIMLE). In a VAL 202, a VAL client 204 (e.g., as part of a UE 104) communicates via a 3GPP network system 206 with VAL servers 208 over a VAL-UU reference point 210. VAL-UU can support unicast and multicast delivery modes. The AIMLE functional entities on the UE 104 and the server are grouped into AIMLE clients 212 and AIMLE servers 214, respectively.

At a service enabler architecture layer (SEAL) 216 for verticals, the system 200 includes of a common set of services for AIML functionality, including FL and distributed learning (e.g., FL client registration management, FL client discovery and selection), and reference points. The AIMLE services can be provided to the VAL 202. The AIMLE clients 212 can communicate with the AIMLE servers 214 over AIML-UU reference points 218. The AIMLE clients 212 can provide functionality to the VAL client 204 over an AIML-C reference point 220. The VAL servers 208 can communicate with the AIMLE servers 214 over AIML-S reference points 222. The AIMLE servers 214 communicate with the 3GPP network system 206 using 3GPP network interfaces 224 specified by the 3GPP network system 206. An AIML-E reference point 228 enables interactions between multiple AIMLE servers 214, e.g., between central and edge AIMLE servers 214. An AIMLE server 214 can interact with an AI/ML repository 230, which serves as repository for AI/ML models and AI/ML participants over AIML-R 232.

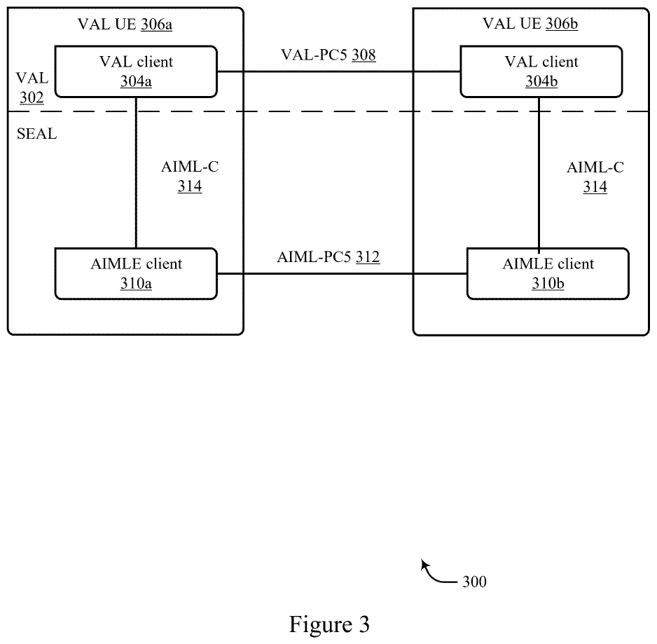

FIG. 3 illustrates an example system 300 in accordance with aspects of the present disclosure. The system 300 represents an example off-network functional model of AIMLE. In a VAL 302, a VAL client 304a at a VAL UE 306a communicates with a VAL client 304b at a VAL UE 306b over VAL-PC5 reference point 308. VAL-PC5 can support unicast and multicast delivery modes. The VAL UE 306a, if connected to the network via a Uu reference point, can also act as a UE-to-network relay to enable the VAL UE 306b to access VAL servers over a VAL-UU reference point. An AIMLE client 310a at the VAL UE 306a can communicate with an AIMLE client 310b at the VAL UE 306b over AIML-PC5 reference points 312. An AIMLE client 310 can provide functionality to the VAL clients 304 over AIML-C reference points 314. Such communication can support local AI/ML operations (training, distribution, inference) in a coordinated manner.

The present disclosure includes solutions for FL in AI/ML. For instance, solutions are provided to secure access to FL resources in wireless communications systems.

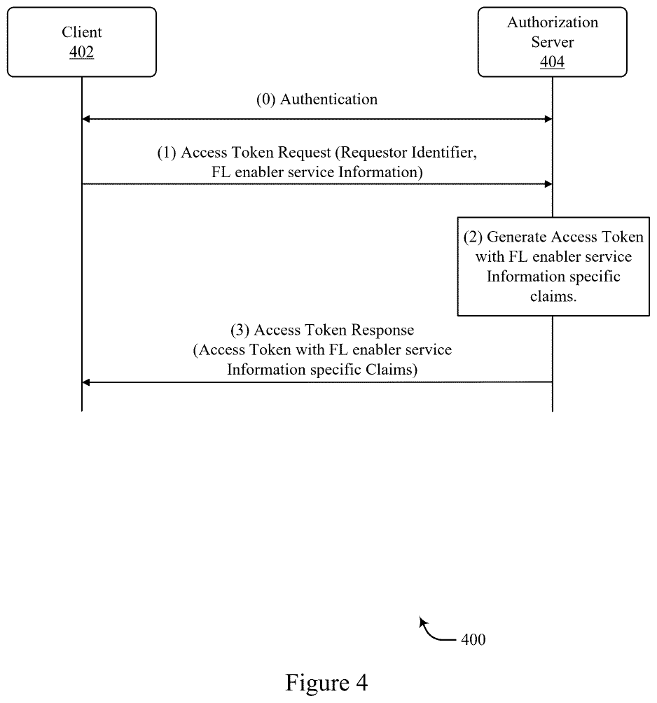

FIG. 4 illustrates an example system 400 in accordance with aspects of the present disclosure. The system 400 can be implemented to authorize a client 402 (e.g., AIMLE client, VAL server, VAL UE) to perform FL enabler service management. Examples of FL enabler service management include FL member registration, FL member registration update, FL related event subscription, notification, HFL training, FL member grouping, supporting VFL services, etc. FL enabler service management may be associated with FL of model information related to one or more ML model ID(s) or analytics ID(s). Authorization of the client 402 can be performed via interaction with an authorization server 404 (e.g., a SIM server, AIMLE server, SEAL server) by issuing an access token or authorization information.

In the system 400: At step (0), the client 402 and the authorization server 404 perform mutual authentication. At step (1), the client 402 communicates an access token request to the authorization server 404. The access token request may include information such as an ID of the client 402 (e.g., requestor identifier) and FL enabler service information. At step (2), and based on the access token request, the authorization server 404 generates an access token with claims that are specific to the FL enabler service information. At step (3), the authorization server 404 communicates an access token response to the client 402 that includes the access token.

In implementations, to obtain an access token (and optionally a refresh token) the client 402 (SEAL client, AIMLE client, VAL Server, VAL UE) can communicate a constrained application protocol (CoAP) request to the authorization server 404 token endpoint by sending the parameters from Table 1 below using the “application/ace+cbor” content format and with a concise binary object representation (CBOR) map in the CoAP payload. Alternatively, or in addition, the access token request can be any of AIMLE service access token request or AIMLE FL service access token request.

TABLE 1

| Parameter | Values |
|---|---|
| scope | This field requests authorization scopes for the access token. This |
| | field requests AIMLE service-related information related to FL |
| | enabler service information related to FL member registration, FL |
| | member registration update, FL related events subscription, FL |
| | related events notification, HFL training, FL member grouping, VFL |
| | training etc. |
| audience | This field requests specific SEAL servers/resources for the access |
| | token. The field requests specific AIMLE server/AIMLE Model |
| | repository for the FL enabler services. |
| cnonce | Can be used if a client-nonce was provided in response to an |
| | unauthorized resource request to a SEAL server/resource. |
| req_cnf | This field includes information about the key the SEAL client wants |
| | to bind to the access token for proof-of-possession. |

For an access token response, if the access token request is valid and authorized, the authorization server 404 can return an access token (and optionally a refresh token) to the client 402 in an access token response message; otherwise, it may return an error. Table 2 includes example access token response parameters.

TABLE 2

| Parameter | Values |
|---|---|
| access_token | This is the issued access token. The access token includes the |
| | claims scope as FL enabler service information related to FL |
| | member registration, FL member registration update, FL related |
| | events subscription, FL related events notification, HFL |
| | training, FL member grouping, VFL training, audience claim as |
| | (AIMLE server/AIMLE Model repository for the AIMLE |
| | related services), VAL service ID/information, VAL server |
| | ID/VAL UE ID/AIMLE Client ID etc., allowed ML model |
| | retrieval filters, and Model Information such as ML Model |
| | ID(s)/address or Analytics IDs.). |
| expires_in | The lifetime in seconds of the access token. |
| refresh_token | This is the issued refresh token. |
| ace_profile | This field indicates the IETF ACE profile the SEAL client shall |
| | use towards the SEAL server/resource. |
| cnf | This field is used for symmetric key usages unless the secret |
| | key is known to the SEAL client (e.g. in case of update of |
| | access rights). |
| rs_cnf | This field is used for asymmetric key usages unless the public |
| | key of the SEAL server is known to the SEAL client (e.g. in |
| | case of update of access rights). |

In implementations, the client 402 may use the access token to make protected and authorized requests to the authorization server 404. Implementations, such as described with reference to the system 400, can be used for an access request related to FL member registration request or FL member registration update request, e.g., using the following adaptations. The client 402 can obtain, in the step (3) access token response message, authorization information or an access token which can include access token claims such as FL member ID as subject, FL member registration service as scope, FL member type (server or client), FL member capabilities, FL related events ID or name, FL type, FL task information, allowed list of member client IDs/client list, allowed location information for member client selection, FL service area of interest, allowed ML model ID list/ML model information for FL, allowed ML model training notification target address, ML model selection filtering criteria, FL member location information, issuer claim as authorization server ID/AIMLE server ID, etc. This information may be received from the authorization server 404 when the access token request in step (1) indicates FL member registration service in the access token request message.

In such implementations, the access token request can include an information element (IE) as described herein, and based on local configuration or authorization information available, the authorization information or the access token claims can additionally include the received information from the access token request.

In implementations, the system 400 can be used for access requests related to FL related events subscription or notification request, e.g., with the following adaptations. The client 402 can obtain, in the step (3) access token response message, authorization information or an access token which can include claims requestor ID as subject, FL-related event subscription service as scope, FL member type (server or client), FL related events ID or name, FL type, FL member ID, FL task information, allowed list of member client IDs/client list, allowed location information for member client selection, allowed ML model ID list/ML model information for FL, allowed ML model training notification target address, ML model selection filtering criteria, issuer claim as authorization server ID/AIMLE server ID/SEAL server ID, etc. This information can be received from the authorization server 404 when the access token request in step (1) indicates FL related events subscription or notification service in the access token request message.

In such implementations, the access token request can include IEs as described herein, and based on local configuration or authorization information, the authorization server 404 can generate the authorization information or the access token claims to additionally include received information from the access token request.

In implementations, the system 400 can be used for access requests related to HFL training service requests, e.g., with the following adaptations. The client 402 can obtain, in the step (3) access token response message, authorization information or an access token which can include claims requestor ID as subject, HFL training service as scope, AIML model (e.g., model ID/type) and model parameters, dataset ID(s), allowed FL members (allowed list of member client IDs) to use as AI MLE clients for HFL or ML model training, training type (VFL or HFL, or both VFL and HFL), allowed AI MLE client selection/filtering criteria, allowed ML model ID list/ML model information for training, F/ML model selection filtering criteria, issuer claim as authorization server ID/AIMLE server ID/SEAL server ID, etc. This information may be obtained from the authorization server 404 when the access token request in step (1) indicates HFL training service in the access token request message.

In implementations where the access token request includes IEs as described herein, the authorization server, based on local configuration or authorization information, can generate the authorization information or access token claims to additionally include received information from the access token request.

In implementations, the system 400 can be used for an access request related to FL member grouping service request, e.g., with the following adaptations. The client 402 may obtain, in the step (3) access token response message, authorization information or access token can include claims requestor ID as subject, FL member grouping service as scope, VAL service ID, service area information, AIML model (e.g., model ID/type), application data analytics and enablement (ADAE) analytics ID, ML model profile information (e.g., ID for which the FL grouping is to be used), ML task information/ID (e.g., FL training task or FL inference task), allowed FL members (allowed list of member client IDs) to use as AI MLE clients/server for FL, training type (VFL or HFL, or both VFL and HFL), allowed AI MLE client selection/filtering criteria, allowed ML model ID list/ML model information for training, FL/ML model selection filtering criteria, issuer claim as authorization server ID/AIMLE Server ID/SEAL server ID, etc. This information may be received from the authorization server 404 when the access token request in step (1) indicates FL member registration service in the access token request message.

In such implementations, the access token request can include an IE as described herein, and based on local configuration or authorization information available, the authorization information or the access token claims can additionally include the received information from the access token request.

In implementations, the system 400 can be used for access requests related to VFL Training service requests, e.g., with the following adaptations. The client 402 may obtain, in the step (3) access token response message, authorization information or an access token which can include claims requestor ID as subject, VFL training service as scope, AIML model (e.g., model ID/type) and model parameters, feature information, dataset ID(s), allowed different data domains information, allowed FL members (allowed list of member client IDs) to use as AI MLE clients for VFL model training (e.g., per domain), training type (VFL), allowed AI MLE client selection/filtering criteria, allowed ML model ID list/ML model information for training, VFL model selection filtering criteria, issuer claim as authorization server ID/AIMLE server ID/SEAL server ID, etc. This information may be received from the authorization server 404 when the access token request in step (1) indicates VFL Training service in the access token request message.

In such implementations, the access token request can include an IE as described herein, and based on local configuration or authorization information available, the authorization information or the access token claims can additionally include the received information from the access token request.

Implementations provide for secure FL member registration using authorization/access permission verification for access control. Implementations, for example, include procedures for the authorization and authorization verification of registration and registration update of candidate FL members in an ML repository. The ML repository may serve as a service registry for the FL members undertaking a task related to the ML model lifecycle, such as ML model local training. Candidate FL members can be application layer entities at the server side (e.g., VAL server, AIMLE server), which can potentially be selected as FL clients or FL server for a particular ASP/vertical parameter. If a VAL server is a candidate FL member, the VAL server can register indirectly via an AIMLE server to the ML repository.

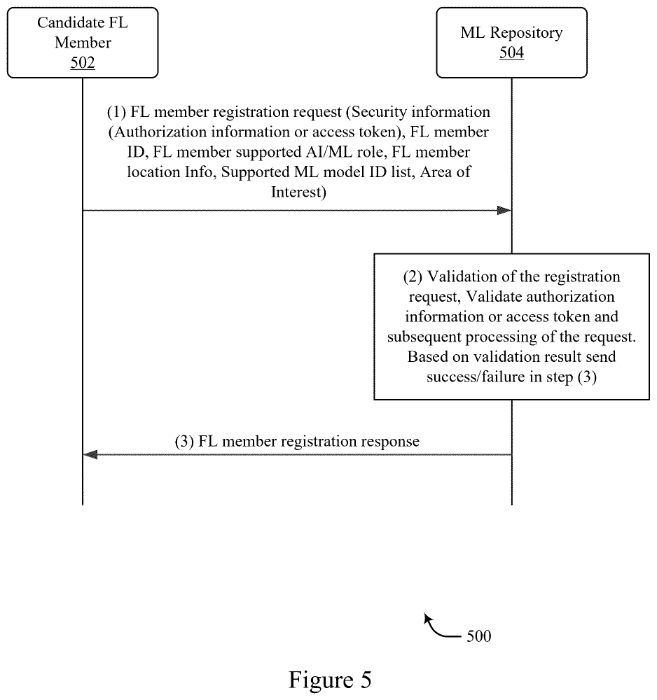

FIG. 5 illustrates a system 500 in accordance with aspects of the present disclosure. The system 500 can be implemented to perform FL member registration. In the system 500, the registration of a candidate FL member 502 can occur via a ML repository 504, e.g., where the ML repository 504 can serve as an AIML service registry.

In examples, if the candidate FL member 502 is a VAL server, the VAL server can register indirectly via an AIMLE server with the ML repository. In examples where the VAL server is the candidate FL member 502 which registers indirectly via an AIMLE server to the ML repository 504, step (1) and (3) described below can be forwarded by the AIMLE server between the candidate FL member 502 and the ML repository 504, respectively.

In the system 500: At step (1), the candidate FL member 502 (e.g., VAL server, AIMLE server) sends an FL member registration request with security credentials (e.g., authorization information or access token) to the ML repository 504 for registering with the ML repository 504. The ML repository can function as an AIML service registry. Authorization information or an access token can include claims FL member ID as subject, FL member registration service as scope, FL member type (server or client), FL member capabilities, FL related events ID or name, FL Type, FL task information, Allowed List of member client IDs/Client List, Allowed location information for member client selection, FL service area of interest, allowed ML model ID list/ML model information for FL, allowed ML model training notification target address, ML model selection filtering criteria, FL member location information, issuer claim as authorization server ID/AIMLE server ID/SEAL server, etc.

Alternatively, or in addition, the VAL server as the candidate FL member 502 at step (1) sends the message to the AIMLE server, and the AIMLE service verifies the security credentials, e.g., authorization information or access token. If the security credentials verification is successful, the AIMLE server can forward the step (1) message to the ML repository 504.

At step (2), the ML repository 504 validates the received request and security credentials (e.g., authorization information or access token), and if the verification is successful, the ML repository 504 generates the identity and other security related information for the FL members listed in the registration request. At step (3), the ML repository 504 sends the generated information in the FL member registration response message to the candidate FL member 502. Alternatively, or in addition, the ML repository 504 sends the generated information in the FL member registration response message from step (3) to the candidate FL member 502 via the AIMLE server.

Implementations include solutions where a registration update of a candidate FL member can be performed via the ML repository. For example, registration update can be implemented via the system 500. At step (1), the candidate FL member 502 (VAL server, AIMLE server) can send an FL member registration update request with security credentials (e.g., authorization information or access token) to the ML repository 504 serving as an AIML service registry for updating the registration of the FL member. Alternatively, or in addition, the candidate FL member 502 can send the step (1) message to an AIML server, and an AIMLE service verifies the security credentials, e.g., authorization information or access token. If the security credentials verification is successful, the AIMLE server can forward the step (1) message to the ML repository 504.

At step (2), the ML repository 504 validates the received update request and security credentials, and if the verification is successful, generates the identity and other security related information for the FL member. At step (3), the ML repository 504 sends the generated information in the FL member registration update response message to the candidate FL member 502. Alternatively, the ML repository sends the generated information in the FL member registration response message in step (3) to the candidate FL member 502 via the AIMLE server.

Table 3 describes IEs for an FL member registration request from the candidate FL member 502 to the ML repository 504. Alternatively, or in addition, authorization information or an access token can be part of security credentials. Alternatively, or in addition, if security credentials and authorization information/access token are included in a separate IE, then security credentials can include client certificate and/or root certificate to validate the client certificate.

TABLE 3

| Information element | Description |
|---|---|
| Security information | Information for ML repository to validate |
| | the registration request. e.g., client |
| | certificate and/or root certificate to |
| | validate the client certificate. |
| Authorization | Authorization information or access token |
| information or | can include claims FL member ID as |
| access token | subject, FL member registration service as |
| | scope, FL member Type (Server or |
| | Client), FL member capabilities, FL |
| | related Events ID or name, FL Type, FL |
| | task information, Allowed List of member |
| | client IDs/Client List, Allowed location |
| | information for member client selection, |
| | FL service Area of Interest, Allowed ML |
| | Model ID list/ML Model Information for |
| | FL, allowed ML model training |
| | notification target address, ML Model |
| | selection filtering criteria, FL member |
| | location information, issuer claim as |
| | authorization server ID/AIMLE Server ID |
| | etc. |
| FL member ID | The identifier of the candidate FL |
| | member. This can be the VAL server ID, |
| | the EAS ID, the AIMLE server ID based |
| | on which entity is the candidate FL |
| | member. |
| FL member supported | The supported AI/ML role of FL member |
| AI/ML role | which can be used as FL server or FL |
| | client. |
| FL member capabilities | FL member capability information (e.g. |
| | ML application type, allowed resource |
| | usage level). |
| FL member velocity | Indicates the FL member velocity (e.g., |
| | mobile or static). |
| FL member Location | Indicates the location information of the |
| information | UE (e.g., Cell Identity, Tracking Area |
| | Identity, GPS Coordinates or civic |
| | addresses). |
| FL member Availability | Availability schedule of the FL member |
| schedule | for a certain FL member. |
| Supported ML model ID | The list of ML model IDs for which the |
| list | FL member can be used. |
| Area of Interest | The area of interest (e.g. location co- |
| | ordinates) for which the registration |
| | applies. |
| Time validity | The time validity for the registration of |
| | the FL member. |

Table 4 describes IEs for the FL member registration response to the candidate FL member 502 from the ML repository 504.

TABLE 4

| Information element | Description |
|---|---|
| Result | The result of the registration request |
| | (positive or negative acknowledgement). |
| Registration ID | The generated ID for the registration. |

Table 5 describes IEs for the FL member registration update request from the candidate FL member 502 to the ML repository 504.

TABLE 5

| Information element | Description |
|---|---|
| Registration ID | Identifier of the existing registration for |
| | which the update request applies. |
| Security information | Information for ML repository to validate |
| | the registration update request, e.g., client |
| | certificate and/or root certificate to |
| | validate the client certificate. |
| Authorization | Authorization information or access token |
| information or | can include claims FL member ID as |
| access token | subject, FL member registration service as |
| | scope, FL member Type (Server or |
| | Client), FL member capabilities, FL |
| | related Events ID or name, FL Type, FL |
| | task information, Allowed List of member |
| | client IDs/Client List, Allowed location |
| | information for member client selection, |
| | FL service Area of Interest, Allowed ML |
| | Model ID list/ML Model Information for |
| | FL, allowed ML model training |
| | notification target address, ML Model |
| | selection filtering criteria, FL member |
| | location information, issuer claim as |
| | authorization server ID/AIMLE Server ID |
| | etc. |
| FL member ID | The identifier of the candidate FL member |
| | for which the update applies. This can be |
| | the VAL server ID, the EAS ID, the |
| | AIMLE server ID based on which entity is |
| | the candidate FL member. |
| Updated registration | The updates of the registration |
| parameters | parameters. |
| >FL member supported | The updated supported AI/ML role of FL |
| AI/ML role | member which can be FL server, FL |
| | client. |
| >FL member Availability | Updated Availability schedule of the FL |
| schedule | member. |
| >supported ML model ID | The updated list of ML model IDs for |
| list | which the FL member can be used |
| >area of interest | The updated area of interest for the |
| | registration update. |
| >time validity | The update time validity for the FL |
| | member registration update. |

Table 6 describes IEs for the FL member registration update response to the candidate FL member 502 from the ML repository 504. Alternatively, or in addition, authorization information or access token can be part of security credentials. Alternatively, or in addition, if security credentials and authorization information/access token are included in a separate IE, then security credentials can include client certificate and/or root certificate to validate the client certificate.

TABLE 6

| Information element | Description |
|---|---|
| Result | The result of the registration update |
| | request (positive or negative |
| | acknowledgement). |
| Registration ID | The generated ID for the new registration |
| | based on the update. |

Implementations provide for secure FL related events subscription and notification via authorization/access permission verification for access control. For example, authorization and authorization verification procedures are described related to subscription for the FL related events and event notification procedures. In examples, a global ML repository can serve as an AIML service registry which monitors the status and changes to the availability and capabilities of the FL members. The subscriber can be the AIMLE server or VAL server which is to be notified on the FL member availability. If VAL server is the subscriber, the VAL server can register indirectly via AIMLE server for FL-related events.

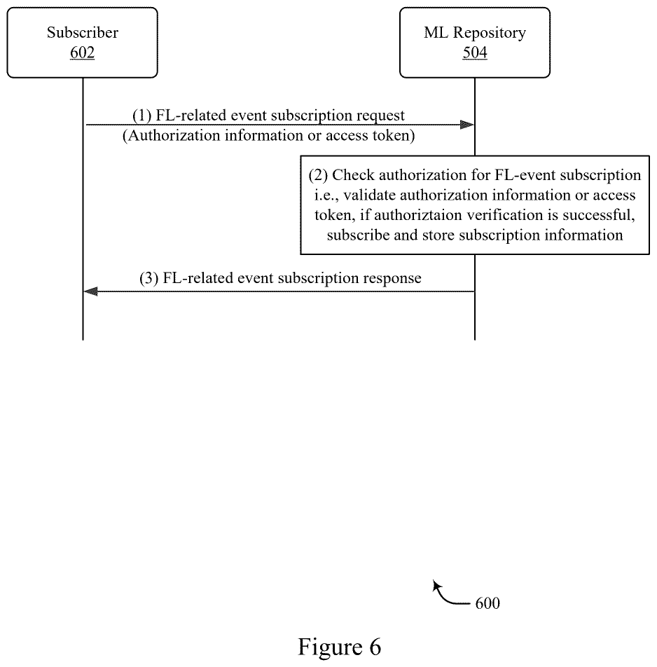

FIG. 6 illustrates a system 600 in accordance with aspects of the present disclosure. The system 600 can be implemented to enable FL related events associated with FL member availability. In examples, the AIMLE server is authorized to subscribe for the FL related events. In scenarios where the VAL server is a subscriber, a request can be sent indirectly via AIMLE server to the ML repository, and step (1) and (3) described with reference to the system 600 can be forwarded by the AIMLE server between the VAL server and the ML repository respectively.

In the system 600: At step (1), a subscriber 602 (AIMLE server, VAL server) sends an FL related event subscription request with security credentials (e.g., authorization information or access token) to the ML repository 504 to receive notification of FL related events and in particular, the availability of an FL member for a target area and time. The authorization information or access token can include claims requestor ID as subject, FL-related event subscription service as scope, FL member Type (server or client), FL related events ID or name, FL Type, FL member ID, FL task information, allowed list of member client IDs/client List, allowed location information for member client selection, allowed ML model ID list/ML model information for FL, allowed ML model training notification target address, ML model selection filtering criteria, issuer claim as authorization server ID/AIMLE server ID/SEAL server ID.

At step (2), upon receiving the event subscription request from the AIMLE server, the ML repository 504 checks for the relevant authorization for the event subscription security credentials (e.g., authorization information or access token) and if the verification is successful, then it determines to generate and store the subscription information in the ML repository. If the authorization is successful, the ML repository stores the subscription information. At step (3), the ML repository sends an FL-related event subscription response to the subscriber 602 indicating successful operation.

Implementations provide for event notification procedure for the FL member availability. This can be triggered based on a change at the availability or capabilities of the candidate or selected FL members. In examples, a subscription procedure was performed by the AIMLE server or VAL server (via AIMLE server). The FL member has registered its capabilities or availability to the ML repository based on the support for FL registration capability.

At step (1), an ML repository detects a change related to the availability of an FL member and generates events to be consumed by the AIMLE server, based on the notification, or based on a received updated registration from FL member, who has already registered at the ML repository. At step (2), for the generated event, the ML repository retrieves the list of corresponding subscriptions. At step (3), the ML repository sends FL-related event notification to entities (e.g., AIMLE servers) that have subscribed for the FL-related event matching the criteria. If a notification reception information is available as part of the FL-related event subscription, then the notification reception information is used by the ML repository to send event notifications to the corresponding AIMLE servers. At step (4), the notified subscriber(s) sends an event notification acknowledgement to the ML repository.

Table 7 includes example definitions of FL related events in accordance with aspects of the present disclosure.

TABLE 7

| Events | Events Description |
|---|---|
| Availability changes | The event type relates to the availability |
| of FL member | change of a FL member. Such availability |
| | change can be an indication of availability |
| | or unavailability for a given service area, |
| | or for a given ML model ID/profile. |
| FL model information | Information such as accuracy, time |
| | schedule and latency for the FL training. |
| | Latency is considering the target latency, |
| | e.g., when the FL model training shall be |
| | completed. |
| FL member load | The event type relates to the monitoring of |
| information | the computational load for the requested |
| | FL member. Such load can be the |
| | estimated (based on measurements) or |
| | expected/predicted based on the tasks that |
| | the FL member undertakes. This event |
| | may be triggered on-demand or can be |
| | monitored periodically. |

Table 8 describes IEs for FL-related event subscription request from the subscriber 602 to the ML repository 504. Alternatively, or in addition, authorization information or access token can be part of security credentials. Alternatively, or in addition, if security credentials and authorization information/access token are included in a separate IE, then security credentials can include client certificate and/or root certificate to validate the client certificate.

TABLE 8

| Information element | Description |
|---|---|
| Requestor Identifier | The identifier to determine the identity of |
| | the requestor entity. This can be the VAL |
| | server ID. |
| Security Credentials | The security credentials of the requestor |
| | e.g., client certificate and/or root |
| | certificate to validate the client certificate. |
| Authorization | Authorization information or access token |
| information or | can include Requestor ID as subject, |
| access token | claims FL-related event subscription |
| | service as scope, FL member Type |
| | (Server or Client), FL related Events ID or |
| | name, FL Type, FL member ID, FL task |
| | information, Allowed List of member |
| | client IDs/Client List, Allowed location |
| | information for member client selection, |
| | Allowed ML Model ID list/ML Model |
| | Information for FL, allowed ML model |
| | training notification target address, ML |
| | Model selection filtering criteria, issuer |
| | claim as authorization server ID/AIMLE |
| | Server ID/SEAL server ID. |
| Time of validity | The time validity for the subscription. |
| ML model information | Information of the ML model for which |
| | the subscription is to be obtained |
| >ML model ID | The identity of the ML model for which |
| | the subscription is to be obtained. |
| FL member information | Information on the FL member (candidate |
| | or selected). |
| >FL member type | The type of FL member which can be an |
| | FL server or FL client. |
| >FL member ID | The ID of the entity serving as FL |
| | member. This can be used for events |
| | where the FL member is known and |
| | possibly selected, and the availability |
| | is to be checked. |
| Event Information | Information on the FL-related event. |
| >Event ID | The identity of the FL-related event (if |
| | known by the requestor). |
| >Event type | The event type requested, based on the |
| | Definition of FL related events. |
| Notification endpoint | The information of the endpoint for |
| | receiving the notifications for the event. |

Table 9 describes IEs for the FL-related event subscription response to the subscriber (e.g. AIMLE server) from the ML repository.

TABLE 9

| Information element | Description |
|---|---|
| Result | Indicates the success or failure of the |
| | event subscription operation. |
| Subscription Identifier | The identifier for the event subscription. |

Table 10 describes IEs for the FL-related event notification from the ML repository to the requestor (e.g., AIMLE server).

TABLE 10

| Information element | Description |
|---|---|
| Subscription identifier | The identifier of the event subscription. |
| Event identifier | The identifier for the event. Different |
| | events are described throughout this |
| | disclosure. |
| Event related information | The event related information (e.g., time |
| | at which the event originated or is planned |
| | to be executed, location of event). |
| Event content | The content of the event information. |
| >List of FL member ID/ | The list of the FL members and their |
| address | addresses. |
| >>FL member enter/ | The indication of an FL member entering |
| leave | or leaving the available list. |
| >>FL member updated | The update of capabilities for the FL |
| capability | members. |
| >>Time availability of | The time period for which the FL member |
| FL member | is available. |
| >>Area of interest | The area of interest or exact or predicted |
| | location for which the event applies. |

Table 11 describes IEs for the FL-related event notification acknowledgement from the AIMLE server to the ML repository.

TABLE 11

| Information element | Description |
|---|---|
| Result | The positive or negative |
| | acknowledgement of the notification |
| | reception. |

Implementations provide for secure HFL training via authorization/access permission verification for access control. AI/ML training can be an iterative process and can be performed over multiple training rounds. In the cases of FL and DL, the training can be performed with multiple AIMLE clients. An AIMLE server can be configured to manage the training process over multiple training rounds for VAL servers. In examples, an HFL training procedure may support HFL, distributed learning, transfer learning, and split AI/ML.

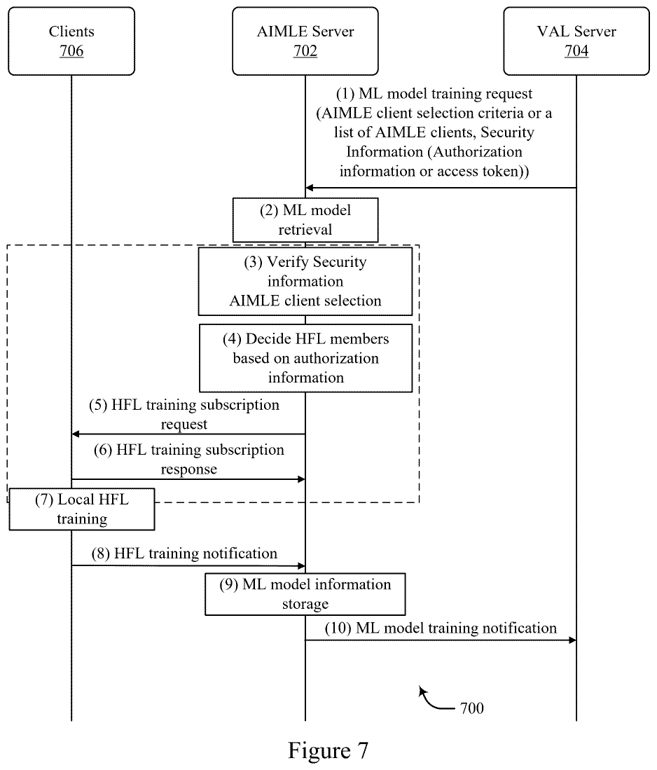

FIG. 7 illustrates a system 700 in accordance with aspects of the present disclosure. The system 700 can be implemented for HFL training. In examples, AIMLE client discovery and selection have been performed. Datasets can be available and prepared for AI/ML training at the AIMLE clients. The datasets can be assigned identifiers for use in HFL training.

In the system 700: At step (1), an AIMLE server 702 receives an ML model training request from a VAL server 704, where the request includes security credentials, e.g., authorization information or access token. If the AIMLE server 702 determines to use HFL training, the procedure continues to step (2). Authorization information or access token can include claims requestor ID as subject, HFL training service (e.g., horizontal federated learning, distributed learning, transfer learning, and split AI/ML) as scope, AIML model (e.g., model ID/type) and model parameters, dataset ID(s), allowed FL members (allowed List of member client IDs) to use as AI MLE clients for HFL or ML model training, training type (VFL or HFL or both VFL and HFL), allowed AIMLE client selection/filtering criteria, allowed ML model ID list/ML model information for training, ML model selection filtering criteria, issuer claim as authorization server ID/AIMLE server ID/SEAL server ID.

At step (2), the AIMLE server verifies the security credentials (e.g., Authorization information or access token), and if the verification is successful, retrieves the indicated ML model. At step (3), for the HFL training, if the security credentials verification is successful, the AIMLE server 702 performs AIMLE client selection using the AIMLE client selection criteria or a list of AIMLE clients provided in step (1) based on the verified authorization information or access token claims. If AIMLE client selection criteria are provided in step (1), then the AIMLE server 702 monitors and selects AIMLE clients 706 for the HFL training. If a list of AIMLE clients is provided in step (1), the AIMLE server 702 selects the provided AIMLE clients 706 for the HFL training based on the verified authorization information or access token claims.

At step (4), based on the AIMLE client set determined in step (3), the AIMLE server 702 based on the verified authorization information or access token claims checks with the selected AIMLE clients 706 for their capability and participation in the HFL training. At step (5), the AIMLE server 702 configures a training schedule for each of the AIMLE clients 706 and sends a HFL training subscription request. At step (6), each AIMLE client 706 sends a HFL training subscription response with information such as described in Table 13. If the AIMLE client 706 is not able to grant the subscription (e.g., is not able to perform the training), the AIMLE client 706 sends a response with a failure status and the system skips to step (8).

At step (7), each AIMLE client performs local training using the configured AI/ML model, model parameters, and the prepared local data associated with the dataset identifier for the specified number of samples according to the operational schedule. At step (8), upon completion or due to errors in the training, each AIMLE client 706 sends a HFL training notification to the AIMLE server 702. The notification includes information as described in Table 14. The AIMLE client 706 provides an AIMLE service ID for the HFL training operation.

At step (9), if errors were encountered, the system 700 skips to step (10). At step (9), if training was successful, the AIMLE server 702 aggregates (e.g. averages) the model parameters received from the AIMLE clients 706. If a training schedule is not complete (e.g., there are remaining training rounds), the AIMLE server 702 configures the next set of training schedules and steps (3) to (8) can be repeated for the next training round. When the training schedule has been completed (e.g. there are no remaining training round), the AIMLE server 702 can perform a ML model information storage request to store the AI/ML model in the ML repository 504. At step (10), the AIMLE server 702 sends a ML model training notification to the VAL server 704.

Table 12 shows the request sent by the AIMLE server 702 to AIMLE clients 706 for an HFL training subscription procedure.

TABLE 12

| Information element | Description |
|---|---|
| Requestor identifier | The identifier of the requestor. |
| Security Credentials | The security credentials of the Requestor, |
| | e.g., client certificate and/or root |
| | certificate to validate the client certificate. |
| Authorization | Authorization information or access token |
| information or | can include claims Requestor ID as subject, |
| access token | HFL training service as scope, AIML Model |
| | (e.g., Model ID/Type) and Model parameters, |
| | Dataset ID(s), Allowed FL members |
| | (Allowed List of member client IDs) to use as |
| | AI MLE clients for HFL (or) ML model |
| | training, Training Type (VFL or HFL or both |
| | VFL and HFL), Allowed AI MLE client |
| | selection/filtering criteria, Allowed ML |
| | Model ID list/ML Model Information for |
| | training, F/ML Model selection filtering |
| | criteria, issuer claim as authorization server |
| | ID/AIMLE Server ID/SEAL server ID. |
| AI/ML model and model | Information about the AI/ML model and |
| parameters | model parameters for use in HFL training. |
| Dataset identifier | The dataset identifier associated with the |
| | dataset used for HFL training. |
| Number of data samples | The number of data samples for a round of |
| | HFL training. |
| Operational schedule | A schedule for when training is to occur. |
| Notification settings | Settings for how often to send notifications |
| | providing status of HFL training. For |
| | example, periodic, event-based (e.g. based on |
| | percentage completion), upon completion of |
| | each training round. |

Table 13 illustrates the response sent by AIMLE clients 706 to the AIMLE server 702 for the HFL training subscription procedure.

TABLE 13

| Information element | Description |
|---|---|
| Status | The status for the subscription request: |
| | success, fail. |
| Subscription ID | An identifier for the subscription only |
| | if the status is success. |
| AIMLE service ID | The service identifier for the AIMLE HFL |
| | training operation. |

Table 14 illustrates the notification sent by AIMLE clients 706 to the AIMLE server 702 for the HFL training subscription procedure.

TABLE 14

| Information element | Description |
|---|---|
| Status | Status for the request: success, fail. |
| AIMLE service ID | The service identifier for the AIMLE HFL |
| | training operation. |
| HFL training output | ML model parameters from HFL training. |
| Errors list | A list of errors encountered during a HFL |
| | training round. |
| Timestamp | A timestamp for the notification. |

Implementations provide for an authorization and authorization verification procedure for the grouping of the FL members using AIMLE. Such grouping for the given FL process can be applicable to a specific VAL request or ML model ID or ADAE analytics ID. This grouping can be applicable also for a given service area in which one or more FL processes are expected to run. The grouping of FL members is performed for optimizing the process of selection and updating FL members which are entering or leaving the group.

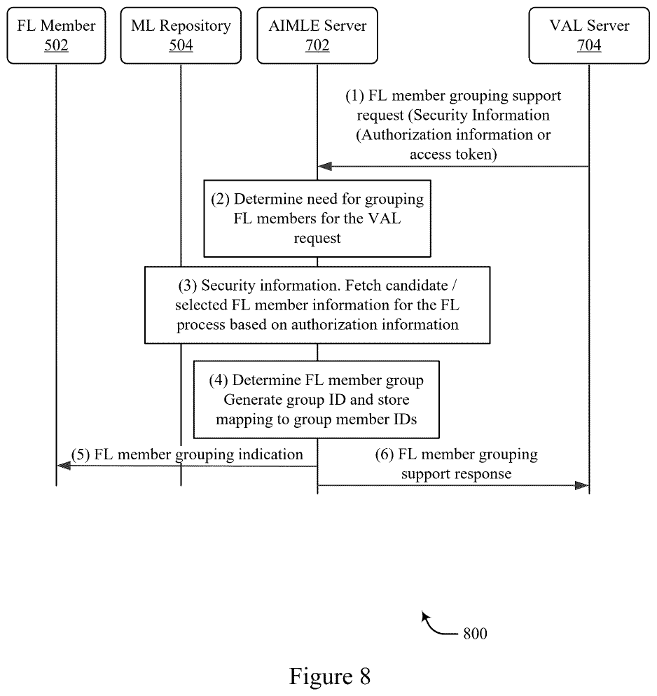

FIG. 8 illustrates a system 800 in accordance with aspects of the present disclosure. In the system 800, the AIMLE support capability is described for grouping the FL members, where the grouping is tailored to a specific ML task (VAL triggered task or analytics event/ID). In examples, the VAL server 704 is connected to the AIMLE server 702. The candidate/selected FL member 502 has registered to the FL member registry based on a capability.

In the system 800: At step (1), the VAL server 704 sends to the AIMLE server an FL member grouping support request with Security credentials e.g., authentication information such as certificates, Authorization information or access token for supporting an FL process. Authorization information or access token can include claims requestor ID as subject, FL member grouping service as scope, VAL service ID, service area information, AIML model (e.g., model ID/type), ADAE analytics ID, ML model profile information (e.g., ID for which the FL grouping is to be used), ML task information/ID (e.g., FL training task or FT inference task), allowed FL members (allowed list of member client IDs) to use as AI MLE clients/server for FL, training type (VFL or HFL or both VFL and HFL), allowed AI MLE client selection/filtering criteria, allowed ML model ID list/ML model information for training, FL/ML model selection filtering criteria, issuer claim as authorization server ID/AIMLE server ID/SEAL server ID, etc.

At step (2), the AIMLE Server 702 based on the request, verifies the Security credentials e.g., authentication information such as certificates, Authorization information or access token. If the verification is successful, the AIMLE server 702 determines to create a group including the FL members for a given ML task (e.g., an ML model training/inference job ID). The FL aggregator can be either the VAL server 702 or the AIMLE server 702, e.g., based on the request. The case for creating a FL member group may be based on an ML task for a given AIMLE service area or for a given AIMLE service area where one or more ML tasks are expected to run, e.g., based on the step (1) request.

At step (3), the AIMLE server 702, based on the verified Security credentials (e.g., authentication information such as certificates, Authorization information or access token), obtains the available FL members 502 for the given ML task (e.g., an ML model training/inference job ID) from the ML repository 504. Based on this information, the AIMLE server 702 (e.g., based on the verified Security credentials e.g., Authorization information or access token) may select one or more FL members 502 for the group for the ML task.

At step (4), the AIMLE Server 702 configures the FL member group based on the available or selected FL members by the FL server/aggregator. Criteria for determining the group members can be the capabilities of the FL participants, or whether the candidate participants are fixed or mobile nodes and their availabilities, and the proximity of the participants. At step (5), the AIMLE Server 702 notifies the candidate FL members (including AIMLE client if the candidate is VAL UEs) of the group ID and the group member identities for the ML model ID/analytics ID based on the request in step (1). At step (6), the AIMLE server 702 sends a FL member grouping support response to the VAL server 704 indicating the group creation and the group information.

Table 15 shows the request sent by the VAL server 704 to AIMLE server 702 for the FL member grouping procedure.

TABLE 15

| Information element | Description |
|---|---|
| Requestor identity | Identity of the VAL server performing the |
| | request. |
| Security Credentials | The security credentials of the Requestor |
| | e.g., client certificate and/or root |
| | certificate to validate the client certificate. |
| Authorization | Authorization information or access token |
| information or | can include claims FL Member grouping |
| access token | service as scope, VAL service ID, Service |
| | area information, AIML Model (e.g., |
| | Model ID/Type), ADAE Analytics ID, |
| | ML Model Profile Information (e.g., ID |
| | for which the FL grouping is to be used), |
| | ML Task Information/ID (e.g., FL |
| | Training task or FT Inference Task), |
| | Allowed FL members (Allowed List of |
| | member client IDs) to use as AI MLE |
| | clients/server for FL, Training Type (VFL |
| | or HFL or both VFL and HFL), Allowed |
| | AI MLE client selection/filtering criteria, |
| | Allowed ML Model ID list/ML Model |
| | Information for training, FL/ML Model |
| | selection filtering criteria, issuer claim |
| | as authorization server ID/AIMLE Server |
| | ID/SEAL server ID etc. |
| VAL service identity | The identity of the VAL service for which |
| | the request applies. |
| ML model ID | The model ID for which the request |
| | applies |
| ADAE analytics ID | The ADAES analytics ID (as specified in |
| | TS 23.436) for which the FL grouping is |
| | to be used, in case when FL process is |
| | used for a given analytics task. |
| ML task information | Information related to the ML task/job |
| | for which the FL grouping is used. Such |
| | task can be an FL training task or FL |
| | inference task. This information may |
| | include an ML task ID which may be an |
| | FL process ID or correlation ID. |
| ML model profile | The ML model profile for which the FL |
| | grouping is to be used. |
| List of candidate/selected | The list of candidate or selected FL |
| FL member IDs | member identities (if known by the VAL |
| | server) which are to be used in the |
| | grouping. |
| | If the FL member is a VAL UE, this is |
| | equivalent to the VAL UE ID. |
| >FL member type | The type of FL members (FL client, FL |
| | server) |
| >FL member status | The status (selected, candidate) of the FL |
| | member. |

Table 16 shows the response sent by the AIMLE server 702 to the VAL server 704 for the FL member grouping procedure.

TABLE 16

| Information element | Description |
|---|---|
| Success response | Indicates that the FL process support |
| | request was successful. |
| >FL group identifier(s) | Identifies the AIMLE-created FL group |
| | for the FL process and ML task (FL |
| | training or inference). |
| >List of FL member IDs/ | Provides the ID and address of the FL |
| addresses | members which are part of the FL group. |
| >>FL member information | Information on the FL members such as |
| | availability, constraints, role/type. |
| Failure response | Indicates that the FL process support |
| | request was failure. |
| >Cause | Reason for the failure. |

Table 17 shows the notification sent by the AIMLE server 702 to the FL members 502 (AIMLE clients, VAL servers) for the FL member grouping procedure.

TABLE 17

| Information element | Description |
|---|---|
| Requestor identity | Identity of the AIMLE server performing |
| | the request. |
| VAL service identity | The identity of the VAL service for which |
| | the grouping indication applies. |
| ML model ID | The model ID for which the indication |
| | applies |
| ADAE analytics ID | The ADAES analytics ID (as specified in |
| | 3GPP TS 23.436) for which the FL |
| | grouping is to be used, in case when FL |
| | process is used for a given analytics task. |
| FL group identifier(s) | Identifies the AIMLE-created FL group |
| | for the FL process. |
| >List of FL member IDs/ | Provides the ID and address of the FL |
| addresses | members which are part of the FL group. |
| >>FL member information | Information on the FL members such as |
| | availability, constraints, role/type. |

Implementations provide for secure support of VFL training procedure by authorization/access permission verification for access control. For example, authorization and authorization verification procedures are provided for supporting VFL among application layer multiple UEs. In examples, VFL members have registered their VFL profile to the AIMLE Server 702. The VFL members may update their status or information in their VFL profile to the AIMLE Server 702. In examples, datasets of each of the UEs (where the AIMLE Clients as VFL members are deployed on) belong to more than one different data domain. The VAL server 704 has successfully subscribed/registered with the AIMLE server 702 for model training notifications.

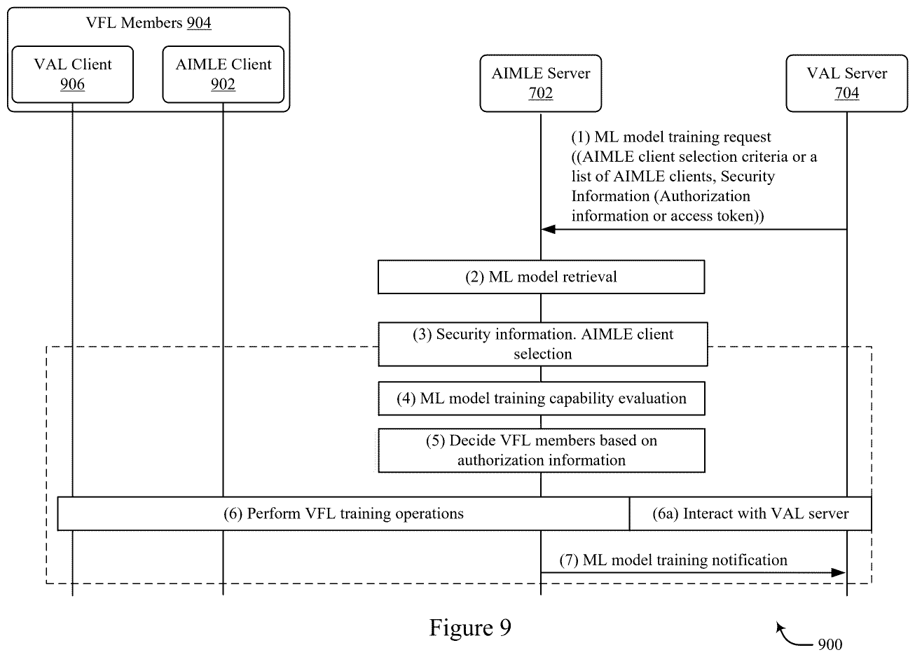

FIG. 9 illustrates a system 900 in accordance with aspects of the present disclosure. The system 900 can be implemented to support VFL. In the system 900: At step (1), an AIMLE server 702 receives an ML model training request with Security credentials (e.g., authentication information such as certificates, Authorization information or access token) from a VAL server 704, such as described throughout this disclosure. If an ML model training request is received and the AIMLE server 702 determines to use VFL training (VFL training between different data domains), the system 900 can proceed to step (2). Authorization information or access token can include claims requestor ID as subject, VFL training service as scope, AIML model (e.g., model ID/Type) and model parameters, feature information, dataset ID(s), allowed different data domains information, allowed FL members (allowed list of member client IDs) to use as AI MLE clients for VFL model training (e.g., per domain), training type (VFL), allowed AIMLE client selection/filtering criteria, allowed ML model ID list/ML model information for training, VFL model selection filtering criteria, issuer claim as authorization server ID/AIMLE server ID/SEAL server ID, etc.

At step (2) (optionally), the AIMLE server 702 verifies the Security credentials (e.g., Authorization information or access token), and if the verification is successful, the AIMLE server 702 retrieves the indicated ML model from step (1) using an ML model retrieval procedure such as described throughout this disclosure. If the retrieved model is already trained and meets the machine learning parameters requested by a consumer, the system 900 can proceed to step (7).

At step (3), if AIMLE client selection criteria are provided in step (1), the AIMLE server 702 based on the verified authentication information such as certificates, authorization information or access token claims, can monitor and select AIMLE clients 902 for the VFL training. If a list of AIMLE clients is provided in step (1), the AIMLE server 702 based on the verified authorization information or access token claims, can select the provided AIMLE clients 902 for the VFL training.

At step (4), the AIMLE server 702 obtains VFL members 904 information (the VFL members information may be included in the request in step (1) or be obtained through step (3). The AIMLE server 702 interacts with the VFL members (AIMLE clients which are deployed on UEs) for each data domain for ML model training capability evaluation. The VFL members 904 may include VAL clients 906.

At step (5), the AIMLE server 702 determines the VFL members for the VFL training process based on the information received in step (4) and parameters received in step (1), and based on the verified authentication information such as certificates, authorization information or access token claims. The AIMLE server 702 determines VFL members 904 for each data domain based on the verified authorization information or access token claims. The criteria used by the AIMLE Server may include: Available data and minimum number of data samples for the same sample among the VFL members 904; feature alignment of the sample/datasets with data labels among the VFL members 904; available time of the VFL members 904 for support the VFL training operations; capability and minimum number of the VFL members 904 for the VFL training operations; AIML model information for the VFL members 904 and for the AIMLE server 702; and successful verification of authentication information such as certificates, authorization information or access token claims.

At step (6), the AIMLE server 702 coordinates the selected VFL members 904 for VFL training. During a VFL training process, the VFL members 904 send intermediate results to the AIMLE server 702, and the AIMLE server 702 responds to the VFL members 904 with the updated information (e.g., gradients). The information from the AIMLE server 702 can be used to update the model parameters maintained at each VFL member 904 for the different data domains. At step (6a), the AIMLE server 702 may report to the VAL server 704 with the training status that includes intermediate training results, and the VAL server 704 may adjust its request for the ML model training. If the VAL server 704 is providing data labels to complete the training, the VAL server 704 may send updated training parameters for the AIMLE server 702 to distribute to the VFL members 904. The updated training parameters may apply for models of VFL members 904 associated with each data domain. At step (7), the AIMLE server 702 sends a ML model training notification to the VAL server 704. If the training schedule is not complete (e.g., there are remaining training rounds), the AIMLE server 702 configures the next set of training schedules, and steps (3) through (6) may be repeated for the next training round.

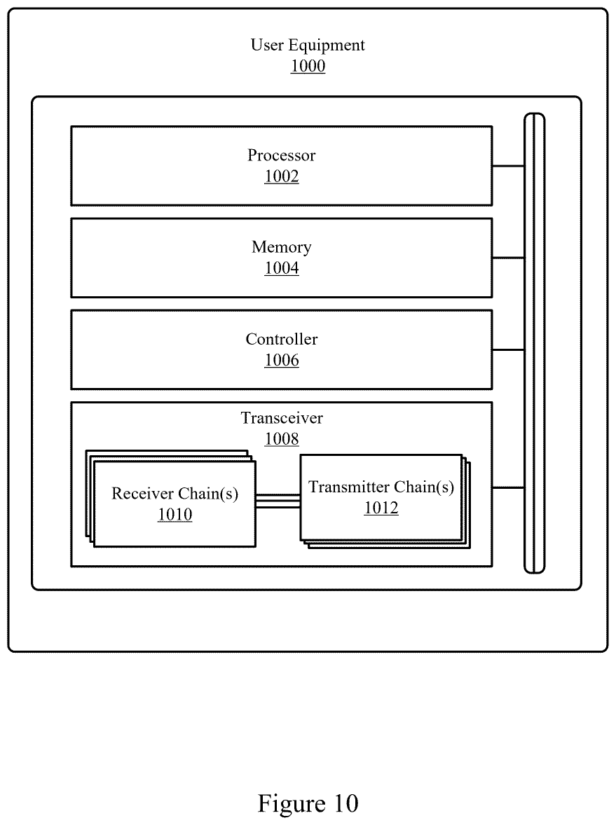

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

Additionally, or alternatively, the UE 1000 may support at least one memory (e.g., the memory 1004) and at least one processor (e.g., the processor 1002) coupled with the at least one memory and configured to cause the UE to transmit a first message including a registration request to register as a FL member, where the first message includes one or more of security credentials, authorization information, or an access token; and receive a second message including a FL member registration response.

Additionally, the UE 1000 may be configured to support any one or combination of where the at least one processor is operable to cause the UE to: transmit a third message including a FL event subscription request, where the third message includes one or more of the security credentials, the authorization information, or the access token; and receive, based at least in part on the FL event subscription request, a fourth message including a FL event subscription response; the apparatus includes one or more of a VAL server, AI/ML client, AIMLE client, AIMLE server, or an AI/ML server; the security credentials include a client certificate or a root certificate configured to validate the client certificate.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

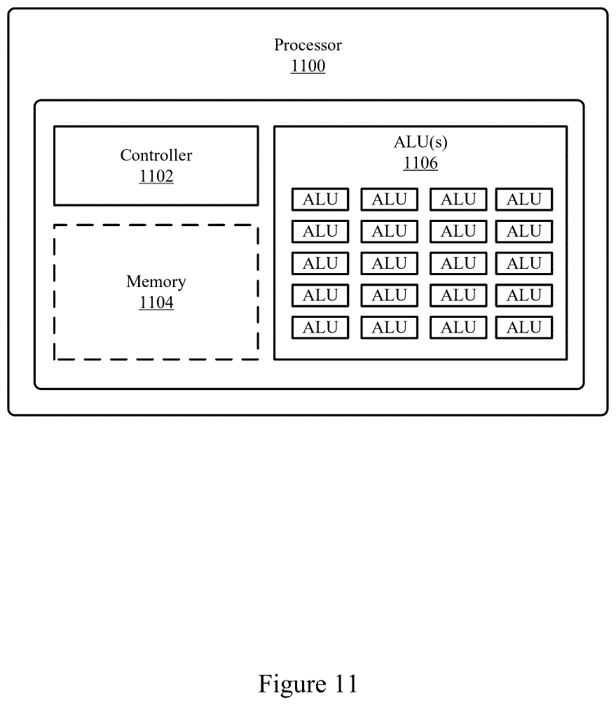

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a first message including a request for an access token, where the first message includes first AI/ML information associated with FL; and transmit a second message including the access token, where the access token includes second AI/ML information associated with FL.

Additionally, the processor 1100 may be configured to or operable to support any one or combination of where the first AI/ML information associated with FL learning includes information associated with one or more of: FL member registration service; FL member registration update service; FL events subscription service; FL events notification service; horizonal HFL training service; FL member grouping service; or vertical FL training service; the access token includes token claims for one or more of: FL member registration; FL events notification; horizontal FL (HFL) training; FL member grouping; FL member ID; FL member type (server or client); FL member capabilities; FL related events ID or name; FL type; FL task information; allowed list of member client IDs/client List; allowed location information for member client selection; FL service area of interest; allowed ML model ID list/ML model information for FL; allowed ML model training notification target address; ML model selection filtering criteria; FL member location information; analytics ID; issuer claim as an authorization server ID or an AIMLE server ID FL member; or vertical FL (VFL) training; the at least one controller is operable to cause the processor to: receive a third message including an AI/ML model training request, where the third message includes security information including one or more of security credentials, authorization information, or the access token; determine one or more FL members based at least in part on a verification of the security information; and transmit, based at least in part on the determined one or more FL members, a fourth message including an AI/ML training response.

Additionally, the processor 1100 may be configured to or operable to support any one or combination of where the AI/ML model training request is associated with horizontal FL; the at least one controller is operable to cause the processor to: receive a third message including a FL grouping request, where the third message includes security information including one or more of security credentials, authorization information, or the access token; obtain, based at least in part on verification of the security information, FL member information; and transmit, based at least in part on the FL member information, a fourth message including a FL grouping response; the at least one controller is operable to cause the processor to: receive a third message including an AI/ML model training request, where the third message includes one or more client selection criteria and security information including one or more of security credentials, authorization information, or the access token; select one or more FL clients based at least in part a verification of the security information and the one or more client selection criteria; and transmit, based at least in part on the selected one or more FL clients, a fourth message including an AI/ML training response; the AI/ML model training request is associated with vertical FL; the apparatus includes an AI/ML server or an AIMLE server.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive a first message including a registration request to register as a FL member, where the first message includes one or more of security credentials, authorization information, or an access token; and transmit a second message including a FL member registration response.

Additionally, the processor 1100 may be configured to or operable to support any one or combination of where the at least one controller is operable to cause the processor to: receive a third message including a FL event subscription request, where the third message includes one or more of the security credentials, the authorization information, or the access token; perform authorization for FL event subscription based at least in part on the one or more of the security credentials, the authorization information, or the access token; and transmit, based at least in part on the authorization for FL event subscription, a fourth message including a FL event subscription response; the apparatus includes an AI/ML repository; the security credentials include a client certificate or a root certificate configured to validate the client certificate.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to transmit a first message including a registration request to register as a FL member, where the first message includes one or more of security credentials, authorization information, or an access token; and receive a second message including a FL member registration response.

Additionally, the processor 1100 may be configured to or operable to support any one or combination of where the at least one controller is operable to cause the processor to: transmit a third message including a FL event subscription request, where the third message includes one or more of the security credentials, the authorization information, or the access token; and receive, based at least in part on the FL event subscription request, a fourth message including a FL event subscription response; the processor includes one or more of a VAL server, AI/ML client, AIMLE client, AIMLE server, or an AI/ML server; the security credentials include a client certificate or a root certificate configured to validate the client certificate.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to transmit a first message including a FL grouping request, where the first message includes one or more of authentication information or an access token; and receive a second message including a FL grouping response.

Additionally, the processor 1100 may be configured to or operable to support any one or combination of where the at least one controller is operable to cause the processor to: transmit a third message including an AI/ML model training request, where the third message includes security information including one or more of security credentials, authorization information, or the access token; and receive, based at least in part on the AI/ML model training request, a fourth message including an AI/ML training response; the AI/ML model training request is associated with horizonal FL; the at least one controller is operable to cause the processor to: transmit a third message including an AI/ML model training request, where the third message includes one or more client selection criteria and security information including one or more of security credentials, authorization information, or the access token; and receive, based at least in part on the AI/ML model training request, a fourth message including an AI/ML training response; the AI/ML model training request is associated with vertical FL; the apparatus includes a VAL server.

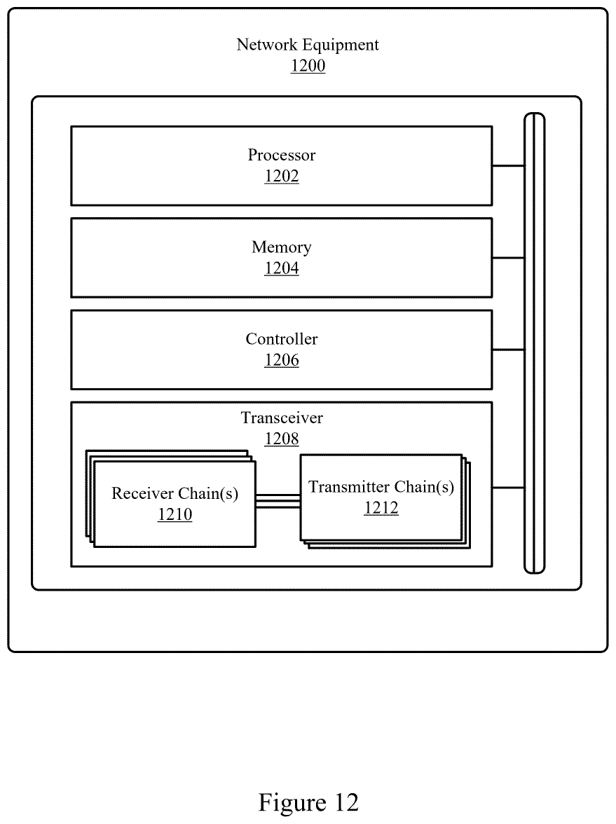

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

Additionally, or alternatively, the NE 1200 may support at least one memory (e.g., the memory 1204) and at least one processor (e.g., the processor 1202) coupled with the at least one memory and configured to cause the NE to receive a first message including a request for an access token, where the first message includes first AI/ML information associated with FL; and transmit a second message including the access token, where the access token includes second AI/ML information associated with FL.

Additionally, the NE 1200 may be configured to support any one or combination of where the first AI/ML information associated with FL learning includes information associated with one or more of: FL member registration service; FL member registration update service; FL events subscription service; FL events notification service; horizonal HFL training service; FL member grouping service; or vertical FL training service; the access token includes token claims for one or more of: FL member registration; FL events notification; horizontal FL (HFL) training; FL member grouping; FL member ID; FL member type (server or client); FL member capabilities; FL related events ID or name; FL type; FL task information; allowed list of member client IDs/client List; allowed location information for member client selection; FL service area of interest; allowed ML model ID list/ML model information for FL; allowed ML model training notification target address; ML model selection filtering criteria; FL member location information; analytics ID; issuer claim as an authorization server ID or an AIMLE server ID FL member; or vertical FL (VFL) training; the at least one processor is operable to cause the apparatus to: receive a third message including an AI/ML model training request, where the third message includes security information including one or more of security credentials, authorization information, or the access token; determine one or more FL members based at least in part on a verification of the security information; and transmit, based at least in part on the determined one or more FL members, a fourth message including an AI/ML training response.

Additionally, the NE 1200 may be configured to support any one or combination of where the AI/ML model training request is associated with horizontal FL; the at least one processor is operable to cause the NE to: receive a third message including a FL grouping request, where the third message includes security information including one or more of security credentials, authorization information, or the access token; obtain, based at least in part on verification of the security information, FL member information; and transmit, based at least in part on the FL member information, a fourth message including a FL grouping response; the at least one processor is operable to cause the NE to: receive a third message including an AI/ML model training request, where the third message includes one or more client selection criteria and security information including one or more of security credentials, authorization information, or the access token; select one or more FL clients based at least in part a verification of the security information and the one or more client selection criteria; and transmit, based at least in part on the selected one or more FL clients, a fourth message including an AI/ML training response; the AI/ML model training request is associated with vertical FL; the apparatus includes an AI/ML server or an AIMLE server.

Additionally, or alternatively, the NE 1200 may support at least one memory (e.g., the memory 1204) and at least one processor (e.g., the processor 1202) coupled with the at least one memory and configured to cause the NE to receive a first message including a registration request to register as a FL member, where the first message includes one or more of security credentials, authorization information, or an access token; and transmit a second message including a FL member registration response.

Additionally, the NE 1200 may be configured to support any one or combination of where the at least one processor is operable to cause the NE to: receive a third message including a FL event subscription request, where the third message includes one or more of the security credentials, the authorization information, or the access token; perform authorization for FL event subscription based at least in part on the one or more of the security credentials, the authorization information, or the access token; and transmit, based at least in part on the authorization for FL event subscription, a fourth message including a FL event subscription response; the apparatus includes an AI/ML repository; the security credentials include a client certificate or a root certificate configured to validate the client certificate.

Additionally, or alternatively, the NE 1200 may support at least one memory (e.g., the memory 1204) and at least one processor (e.g., the processor 1202) coupled with the at least one memory and configured to cause the NE to transmit a first message including a registration request to register as a FL member, where the first message includes one or more of security credentials, authorization information, or an access token; and receive a second message including a FL member registration response.

Additionally, the NE 1200 may be configured to support any one or combination of the at least one processor is operable to cause the NE to: transmit a third message including a FL event subscription request, where the third message includes one or more of the security credentials, the authorization information, or the access token; and receive, based at least in part on the FL event subscription request, a fourth message including a FL event subscription response; the apparatus includes one or more of a VAL server, AI/ML client, AIMLE client, AIMLE server, or an AI/ML server; the security credentials include a client certificate or a root certificate configured to validate the client certificate.

Additionally, or alternatively, the NE 1200 may support at least one memory (e.g., the memory 1204) and at least one processor (e.g., the processor 1202) coupled with the at least one memory and configured to cause the NE to transmit a first message including a FL grouping request, where the first message includes one or more of authentication information or an access token; and receive a second message including a FL grouping response.

Additionally, the NE 1200 may be configured to support any one or combination of where the at least one processor is operable to cause the NE to: transmit a third message including an AI/ML model training request, where the third message includes security information including one or more of security credentials, authorization information, or the access token; and receive, based at least in part on the AI/ML model training request, a fourth message including an AI/ML training response; the AI/ML model training request is associated with horizonal FL; the at least one processor is operable to cause the NE to: transmit a third message including an AI/ML model training request, where the third message includes one or more client selection criteria and security information including one or more of security credentials, authorization information, or the access token; and receive, based at least in part on the AI/ML model training request, a fourth message including an AI/ML training response; the AI/ML model training request is associated with vertical FL; the NE includes a VAL server.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

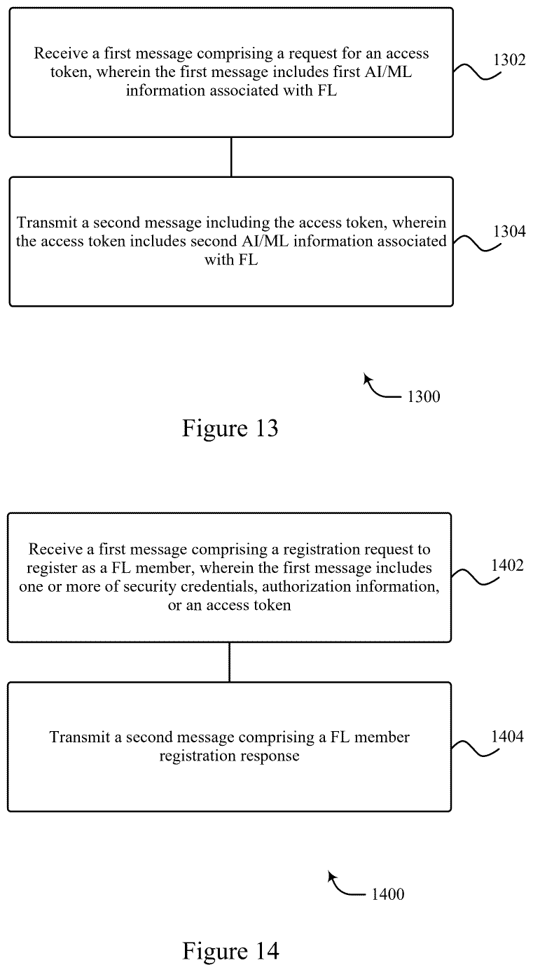

FIG. 13 illustrates a flowchart of a method 1300 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include receiving a first message including a request for an access token, where the first message includes first AI/ML information associated with FL. The operations of 1302 may be performed in accordance with examples as described herein. In some implementations, aspects of the operations of 1302 may be performed by an NE as described with reference to FIG. 12.

At 1304, the method may include transmitting a second message including the access token, where the access token includes second AI/ML information associated with FL. The operations of 1304 may be performed in accordance with examples as described herein. In some implementations, aspects of the operations of 1304 may be performed by an NE as described with reference to FIG. 12.

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include receiving a first message including a registration request to register as a FL member, where the first message includes one or more of security credentials, authorization information, or an access token. The operations of 1402 may be performed in accordance with examples as described herein. In some implementations, aspects of the operations of 1402 may be performed by an NE as described with reference to FIG. 12.

At 1404, the method may include transmitting a second message including a FL member registration response. The operations of 1404 may be performed in accordance with examples as described herein. In some implementations, aspects of the operations of 1404 may be performed by an NE as described with reference to FIG. 12.

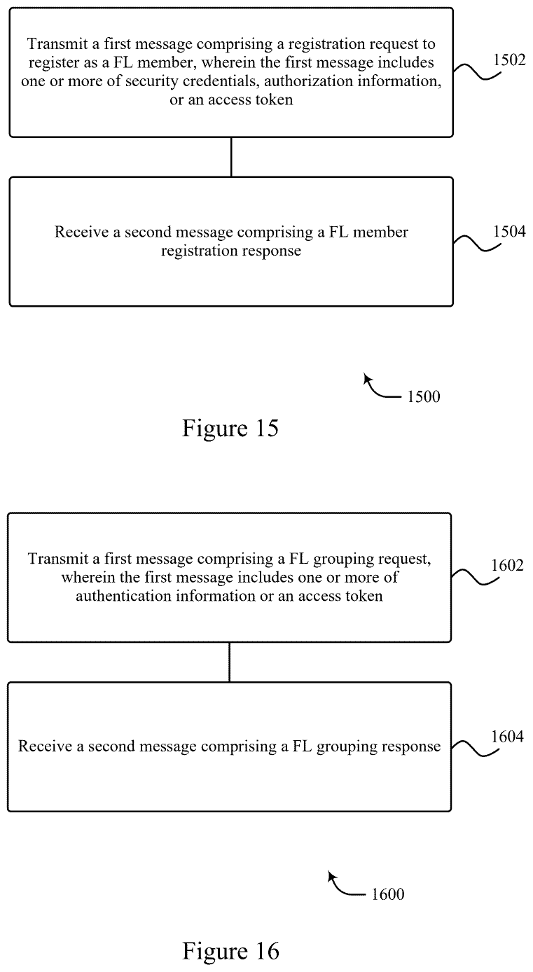

FIG. 15 illustrates a flowchart of a method 1500 in accordance with aspects of the present disclosure. The operations of the method may be implemented by a NE and/or a UE as described herein. In some implementations, the NE and/or the UE may execute a set of instructions to control the function elements of the NE and/or the UE to perform the described functions. It should be noted that the method described herein describes a possible implementation, and that the operations and the steps may be rearranged or otherwise modified and that other implementations are possible.

At 1502, the method may include transmitting a first message including a registration request to register as a FL member, where the first message includes one or more of security credentials, authorization information, or an access token. The operations of 1502 may be performed in accordance with examples as described herein. In some implementations, aspects of the operations of 1502 may be performed by a UE as described with reference to FIG. 10 and/or an NE as described with reference to FIG. 12.

At 1504, the method may include receiving a second message including a FL member registration response. The operations of 1504 may be performed in accordance with examples as described herein. In some implementations, aspects of the operations of 1504 may be performed by a UE as described with reference to FIG. 10 and/or an NE as described with reference to FIG. 12.

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting a first message including a FL grouping request, where the first message includes one or more of authentication information or an access token. The operations of 1602 may be performed in accordance with examples as described herein. In some implementations, aspects of the operations of 1602 may be performed by an NE as described with reference to FIG. 12.

At 1604, the method may include receiving a second message including a FL grouping response. The operations of 1604 may be performed in accordance with examples as described herein. In some implementations, aspects of the operations of 1604 may be performed by an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and operable to cause the apparatus to:
receive a first message comprising a request for an access token, wherein the first message includes first artificial intelligence (AI) machine learning (ML) information associated with federated learning (FL); and
transmit a second message including the access token, wherein the access token includes second AI/ML information associated with FL.

2. The apparatus of claim 1, wherein the first AI/ML information associated with FL learning comprises information associated with one or more of:
FL member registration service;
FL member registration update service;
FL events subscription service;
FL events notification service;
horizonal HFL training service;
FL member grouping service; or
vertical FL training service.

3. The apparatus of claim 1, wherein the at least one processor is operable to cause the apparatus to:
receive a third message comprising an AI/ML model training request, wherein the third message includes security information comprising one or more of security credentials, authorization information, or the access token;
determine one or more FL members based at least in part on a verification of the security information; and
transmit, based at least in part on the determined one or more FL members, a fourth message comprising an AI/ML training response.

4. The apparatus of claim 3, wherein the AI/ML model training request is associated with horizontal FL.

5. The apparatus of claim 1, wherein the at least one processor is operable to cause the apparatus to:
receive a third message comprising a federated learning (FL) grouping request, wherein the third message includes security information comprising one or more of security credentials, authorization information, or the access token;
obtain, based at least in part on verification of the security information, FL member information; and
transmit, based at least in part on the FL member information, a fourth message comprising a FL grouping response.

6. The apparatus of claim 1, wherein the at least one processor is operable to cause the apparatus to:
receive a third message comprising an AI/ML model training request, wherein the third message includes one or more client selection criteria and security information comprising one or more of security credentials, authorization information, or the access token;
select one or more FL clients based at least in part a verification of the security information and the one or more client selection criteria; and
transmit, based at least in part on the selected one or more FL clients, a fourth message comprising an AI/ML training response.

7. The apparatus of claim 6, wherein the AI/ML model training request is associated with vertical FL.

8. The apparatus of claim 1, wherein the apparatus comprises an AI/ML server or an AI/ML enabler (AIMLE) server.

9. An apparatus for wireless communication, comprising:
at least one memory; and
at least one processor coupled with the at least one memory and operable to cause the apparatus to:
receive a first message comprising a registration request to register as a federated learning (FL) member, wherein the first message includes one or more of security credentials, authorization information, or an access token; and
transmit a second message comprising a FL member registration response.

10. The apparatus of claim 9, wherein the at least one processor is operable to cause the apparatus to:
receive a third message comprising a FL event subscription request, wherein the third message includes one or more of the security credentials, the authorization information, or the access token;
perform authorization for FL event subscription based at least in part on the one or more of the security credentials, the authorization information, or the access token; and
transmit, based at least in part on the authorization for FL event subscription, a fourth message comprising a FL event subscription response.

11. The apparatus of claim 9, wherein the apparatus comprises an AI/ML repository.

12. The apparatus of claim 9, wherein the security credentials comprise a client certificate or a root certificate configured to validate the client certificate.

13. An apparatus for wireless communication, comprising:
at least one memory; and
at least one processor coupled with the at least one memory and operable to cause the apparatus to:
transmit a first message comprising a registration request to register as a federated learning (FL) member, wherein the first message includes one or more of security credentials, authorization information, or an access token; and
receive a second message comprising a FL member registration response.

14. The apparatus of claim 13, wherein the at least one processor is operable to cause the apparatus to:
transmit a third message comprising a FL event subscription request, wherein the third message includes one or more of the security credentials, the authorization information, or the access token; and
receive, based at least in part on the FL event subscription request, a fourth message comprising a FL event subscription response.

15. The apparatus of claim 13, wherein the apparatus comprises one or more of a vertical application layer (VAL) server, AI/ML client, AI/ML enabler (AIMLE) client, AIMLE server, or an AI/ML server.

16. The apparatus of claim 13, wherein the security credentials comprise a client certificate or a root certificate configured to validate the client certificate.

17. An apparatus for wireless communication, comprising:
at least one memory; and
at least one processor coupled with the at least one memory and operable to cause the apparatus to:
transmit a first message comprising a federated learning (FL) grouping request, wherein the first message includes one or more of authentication information or an access token; and
receive a second message comprising a FL grouping response.

18. The apparatus of claim 17, wherein the at least one processor is operable to cause the apparatus to:
transmit a third message comprising an AI/ML model training request, wherein the third message includes security information comprising one or more of security credentials, authorization information, or the access token; and
receive, based at least in part on the AI/ML model training request, a fourth message comprising an AI/ML training response.

19. The apparatus of claim 18, wherein the AI/ML model training request is associated with horizonal FL.

20. The apparatus of claim 17, wherein the at least one processor is operable to cause the apparatus to:
transmit a third message comprising an AI/ML model training request, wherein the third message includes one or more client selection criteria and security information comprising one or more of security credentials, authorization information, or the access token; and
receive, based at least in part on the AI/ML model training request, a fourth message comprising an AI/ML training response.
